(19) United States
(12) Patent Application Publication
(10) Pub. No.: US 2007/0067410 A1
(43) Pub. Date: Mar. 22, 2007

(54) Method and apparatus for the surveillance, monitoring, management and control of vehicular traffic

(76) Inventor: Bryan P. Mulligan, Suwanee, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/230,403

(22) Filed: Sep. 20, 2005

(51) Int. Cl. G06F 15/16

(52) U.S. Cl. 709/217

(57) ABSTRACT

Information is communicated both between one of a number of network server devices disposed in proximity to corresponding traffic devices and between such a network server device and a remote client device. The traffic devices can include intersection traffic signals, roadway sensors, message signs, video cameras, etc. Each network server device acts as a sensor for its corresponding traffic device to facilitate communication of information between the traffic device and a remote client device.

### BACKGROUND OF THE INVENTION

Roadway traffic management systems have evolved considerably from the days when intersection traffic signals had to be individually programmed at a nearby electrical cabinet to set their timing cycles. Nowadays, traffic signals as well as other traffic devices located throughout a city or metropolitan region, including electronic message signs, traffic-monitoring video cameras, and vehicle sensors embedded in the roadway, are commonly in electronic communication with a central computer system operated by a local or state government agency. Some of these devices may communicate with the central computer system via dedicated optical fiber lines or copper wires, others via connections to the telephone network, and still others via wireless (radio) networks. Personnel operating the central computer system generally can remotely: program traffic signals, monitor the status of traffic signals, monitor roadway vehicle sensors, adjust and monitor video cameras, program roadway message signs, and monitor most of these devices for malfunctions, error conditions and maintenance needs. The central computer system may be networked to other computers accessible to authorized personnel.

A World Wide Web server (“Web server”) can be among the computers included in the network to which the central computer system belongs. Authorized personnel can use a client computer connected to the Internet to interact with the Web server via a secure Internet connection. The Web server can thus provide a Web-based user interface to personnel accessing the central computer system. In this manner, personnel can perform, using a Web browser on a suitable computing system or device, some or all of the above-listed tasks that personnel can perform using the central computer system itself. For example, a user can select a traffic signal, video camera, or message sign to monitor or program. The Web server creates and serves a Web page (form) into which the user can enter, for example, information to select the device from among those devices connected to the central computer system. In response to receiving the information, the central computer system performs any actions indicated by the received information, such as programming, adjusting or otherwise controlling a traffic device, and creates and serves Web pages that include any requested information retrieved from the device, confirm that the device has been programmed or adjusted as requested, etc. The requested information can include video or still images captured from a selected camera.

Systems of the type described above can be difficult to maintain because there are a myriad of traffic devices connected to the central computer via a mix of dedicated lines, telephone lines, and wireless connections. Programming changes or updates to the system may need to be customized to account for the manner in which each device is connected. In addition, the reliability of systems of the type described above is tied to the reliability of the central computer system. If the central computer system malfunctions, it can adversely affect the operation of the entire traffic management system. Similarly, as the communication lines converge upon a central location, there is increased potential for damage to multiple communication lines due to natural disasters and malicious acts occurring in the vicinity of the central computer system.

It would be desirable to provide a system for managing vehicular traffic that is more robust, more flexible, and easier to maintain than prior systems. The present invention addresses these problems and deficiencies and others in the manner described below.

### SUMMARY OF THE INVENTION

The present invention relates to communicating information both between one of a number of network server devices disposed in proximity to corresponding traffic devices and between such a network server device and a remote client device. The traffic devices can be of conventional types, such as intersection traffic signals, roadway sensors, message signs, video cameras, etc., and are disposed in or near a roadway in the conventional manner. Each network server device acts as a server for its corresponding traffic device to facilitate communication of information between the traffic device and a remote client device in a client-server manner, such as in accordance with the hypertext transfer protocol (HTTP) of the Internet hypertext communication service currently known as the World Wide Web or the Internet file transfer protocol (FTP). Thus, for example, a properly authorized user of a remote client device, such as a computer or a Web-enabled PDA or cellular telephone, can program intersection traffic signals and view their status, view video imagery of traffic conditions gathered by a traffic device having a camera, view the results of detection of passing vehicles by traffic sensors embedded in the roadway, program and view roadway message signs, and control and view the status of various other types of traffic devices.

Each network server device performs some processing of the communicated information, such as authenticating the user who is requesting information to ensure the user is authorized, encoding or decoding information, generating Web pages containing the information, analyzing the information, etc.

Users who have a predetermined requisite level of authorization may be permitted to effect functions that users having a lower level of authorization or different level of authorization are not permitted to effect. For example, some users, such as those authorized by governmental bodies charged with traffic management, may be enabled to program traffic signals and affect the operation of the system in similar ways, while other users, such as those who merely subscribe to a service made publicly available to motorists, may be enabled only to, for example, view images gathered by roadway cameras. With regard to such motorists, those having mobile client devices, such as Web-enabled cellular phones, PDA's and similar devices, can view imagery of traffic conditions ahead or along potential alternate routes while in their vehicles.

The network server device can, in some embodiments of the invention, analyze information received from a traffic device to determine if, for example, a measured quantity exceeds a predetermined threshold. For example, sensors for monitoring weather conditions, pollutants, hazardous contaminants and materials, and so forth, can be read by the network server device, which can communicate an alert to a designated client device if the measured quantity exceeds the threshold.

### BRIEF DESCRIPTION OF THE DRAWINGS

FIG. 1 is a pictorial diagram of a portion of a traffic management system in accordance with an exemplary embodiment of the present invention.

FIG. 2 is a diagram similar to FIG. 1, showing various exemplary traffic devices in the system.

FIG. 3 is a block diagram of a network server device of the system of FIGS. 1 and 2.

FIG. 4 is a flow diagram, illustrating a generalized method of operation of the system of FIGS. 1 and 2.

FIG. 5 is a flow diagram, illustrating an example of use of the system of FIGS. 1 and 2.

FIG. 6 depicts an exemplary Web page generated by a server device of the system of FIGS. 1 and 2.

FIG. 7 is a flow diagram, illustrating another example of use of the system of FIGS. 1 and 2.

FIG. 8 is a flow diagram, illustrating still another example of use of the system of FIGS. 1 and 2.

### DETAILED DESCRIPTION

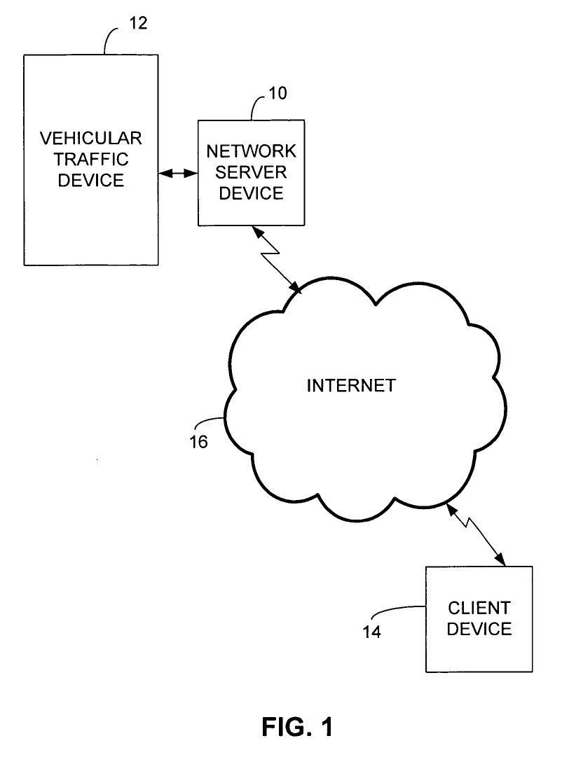

As illustrated in FIG. 1, in an exemplary embodiment of a system for managing vehicular traffic, an exemplary network server device 10, which can be one of many such network server devices in the system, can communicate information with a corresponding traffic device 12 using any of a variety of types of interfaces (described below in further detail) and can communicate with a client device 14 via the global computer network currently referred to as the Internet 16 using the service and set of protocols currently referred to as the World Wide Web or a similar graphical hypertext service and protocols. Thus, in the exemplary embodiment of the invention client device 14 sends and receives information to and from network server device 10 in a client-server manner using Web pages or similar graphical means for communicating information. For example, client device 14 can send requests to network server device 10 for information from traffic device 12 regarding its status or information gathered by traffic device 12, such as video imagery gathered by a camera or the outputs of other sensors associated with traffic device 12, and then can receive the results of the request from network server device 10. Client device 14 can also send requests to program, configure, or otherwise affect the operation of traffic device 12 and its associated sensors and other elements, and then can receive the results of the request, such as updated status information. In an instance in which the information sent from client device 14 is a request for information from traffic device 12 or a request to affect the operation of traffic device 12, network server device 10 receives the request, processes the request in a suitable manner (as described in further detail below), obtains the requested information from traffic device 12 or, alternatively, causes traffic device 12 to alter its operation accordingly, and transmits any results to client device 14.

Although in the exemplary embodiment of the invention the network through which the network server devices communicate with the traffic devices is the Internet 16, in other embodiments of the invention the network can be any other suitable type of computer network, such as an intranet, i.e., a private network within an organization such as a governmental agency or department charged with traffic management.

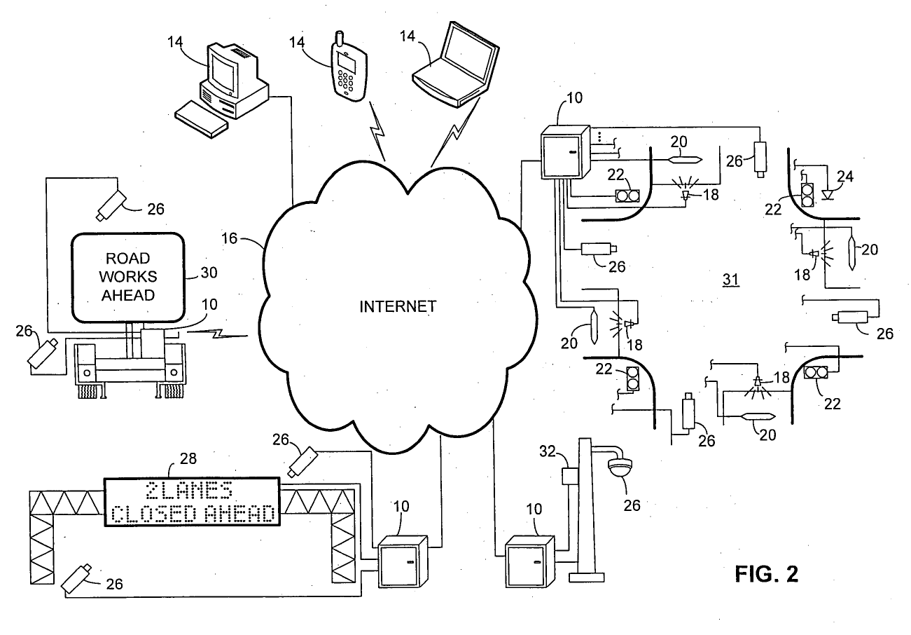

As indicated in FIG. 2, the scope of the meaning of the term “traffic device” includes intersection traffic signals 18, roadway sensors 20, pedestrian crossing signals 22, crossing signal pushbuttons 24, video camera devices 26, overhead electronic message signs 28, portable electronic message signs 30, and other types of devices that have been conventionally controlled or monitored by conventional centralized traffic management systems of the type described above, as well as similar devices that will readily occur to persons skilled in the art in view of these teachings. The term “traffic device” does not include devices that are not inherently related to the monitoring or control of traffic, such as a stand-alone camera not pointed toward a roadway or traffic-related area or otherwise associated with vehicular traffic, a message sign that is not installed within view of a roadway, and pushbuttons and sensors that are not specifically related to vehicular traffic. Nevertheless, as described below, benefits of the invention include the capability of also monitoring pedestrian traffic and other events occurring on or near roadways and monitoring for detection of pollutants, hazardous contaminants and materials on or near roadways. All of the traffic devices 18-30 are located or installed in the field (i.e., near a roadway) within the same localized managed traffic area, such as a city, district of a city, or other geographical area in which traffic is conventionally managed in a coordinated manner by a governmental or official body.

As illustrated in FIG. 2, each of traffic devices 18-30 is in communication with a corresponding or associated network server device 10. As the term “traffic device” can also include a group of traffic devices that are integrated with one another or cooperate in some manner such that they are effectively part of the same device or unit, such as devices that are installed at the same intersection 31 or otherwise relate to the same roadway feature, the number of traffic devices corresponds to the number of network server devices 10. That is, for every traffic device in the system, i.e., in the same localized managed traffic area, there is a corresponding network server device 10. For example, with regard to the exemplary embodiment of the invention shown in FIG. 2, one network server 10 is illustrated as being in communication with intersection traffic signals 18, roadway sensors 20, pedestrian crossing signals 22, crossing signal pushbuttons 24, and video camera devices 26, all of which are associated with a particular intersection 31; another network server 10 is illustrated as being in communication with overhead electronic message sign 28 and two associated camera devices 26 pointed in opposing traffic directions along the roadway beneath sign 28; still another network server 10 is illustrated as being in communication with portable electronic message sign 30 and two associated camera devices 26 pointed in opposing traffic directions along the roadway alongside sign 30; and yet another network server device 10 is illustrated as being in communication with a camera device 26 mounted on a pole above or alongside a roadway. Also illustrated as mounted on that pole is an environmental sensor 32, which is described below in further detail.

Although depicted for purposes of illustration as a weatherproof cabinet or enclosure in FIG. 2, each network server device 10 comprises an electronic assembly housed inside the cabinet, in some instances along with other electronics, such as conventional electronic traffic device controls of the type that may also be in communication with a central computer system (not shown) in the conventional manner. The cabinet or enclosure is located in the vicinity of its associated traffic device, such as in one corner of an intersection, and typically no farther than a few hundred feet from its associated traffic device.

Although not shown in FIG. 2 for purposes of clarity, network server devices 10 can also be connected to traffic devices that are not necessarily located near a roadway, such as a mass transit system computer system that can provide bus schedules and other mass transit traffic information that may be of interest to an authorized person operating a client device 14 in accordance with the invention. Likewise, a network server device 10 can monitor highway advisory radio broadcasts and re-transmit the information to client devices.

As also illustrated in FIG. 2, client devices 14 can be of various types, including desktop and laptop computers and mobile wireless devices such as Web-enabled cellular telephones, PDA's, and variations and hybrids thereof. Essentially anything that is capable of connecting to the Internet 16 and providing a user interface to the Web or similar service can be a “client device” as that term is used herein.

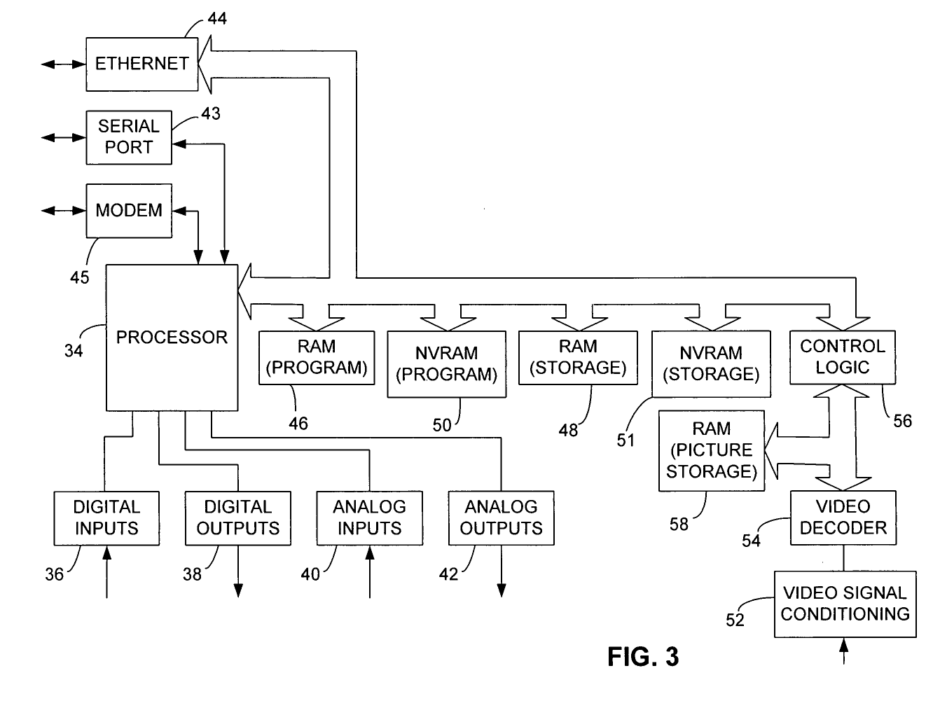

As illustrated in FIG. 3, in an exemplary embodiment of the invention, each network server device 10 includes a processor system 34 that controls the other elements of network server device 10 in accordance with suitable programming. To interface readily with a variety of traffic devices 18-30 (FIG. 2), a variety of interface circuitry can be included: digital input circuitry 36, digital output circuitry 38, analog input circuitry 40, analog output circuitry 42. To interface with the Internet 16 (FIGS. 1-2), an Ethernet interface 44 or similar network interface is included, as are a serial port 43 and modem 45. Also included are random access memory (RAM) 46 and 48 for storing programming and temporary data, respectively, as well as non-volatile random access memory (NVRAM) 50 and 51 (e.g., FLASH memory) for storing programming and data, respectively. To interface with camera devices 26 (FIG. 2), video signal conditioning circuitry 52, a video decoder 54 and suitable control logic 56 are included. Any traffic device that includes a camera can be connected to video signal conditioning circuitry 52. Additional RAM 58 is included to store pictures (still or video) gathered by the camera. Other types of traffic devices (see FIG. 2) can be connected to digital or analog input and output circuitry 36-42.

As processor system 34 is fully programmable, input and output circuitry 36-42 need not be specially adapted to any specific type of traffic device. Network server device 10 can interface and communicate information with essentially any type of traffic device known in the art, regardless of whether its inputs and outputs are digital or analog (or video). Thus, for example, digital output circuitry 38 can be connected to intersection traffic signals 18 (FIG. 2) to provide programming information, while digital input circuitry 36 can be connected to intersection traffic signals 18 to read their status. Likewise, in other instances, digital input circuitry 36 can be connected to roadway sensors 20, and in still other instances to pedestrian crossing signals 22, crossing signal pushbuttons 24, and so forth. Analog input and output circuitry 40 and 42 can be connected to analog traffic devices, such as environmental sensor 32 and street lamps (not shown) that may be included in the system. Analog quantities that can be read include, for example, analog sensor outputs, photocell outputs, battery voltages, signal strengths, etc. Persons skilled in the art to which the invention relate will readily be capable of connecting any type of traffic device to network server device 10 and providing suitable programming to enable network server device 10 to interact with the traffic device as well as with a remote client device 14 via the Internet 16. Such programming can be uploaded to network server device 10 from a client device 14 or similar source via the Internet 16. To provide a connection to the Internet 16, when network server device 10 is installed in the field (i.e., near the location of a corresponding traffic device), Ethernet interface 44 can be connected to a suitable branch, sub-branch, etc., of the Internet 16, either through a direct, wired or wireless Internet connection or indirectly through one or more intermediary Internet Service Providers, as known in the art. Alternatively or in addition, when network server device 10 is installed in the field, modem 45 can be connected to the public telephone network, either directly through a landline (i.e., wire) or indirectly through a cellular telephone or similar device (not shown for purposes of clarity). Serial port 43 can also be used to access the Internet or to communicate with other external devices (not shown).

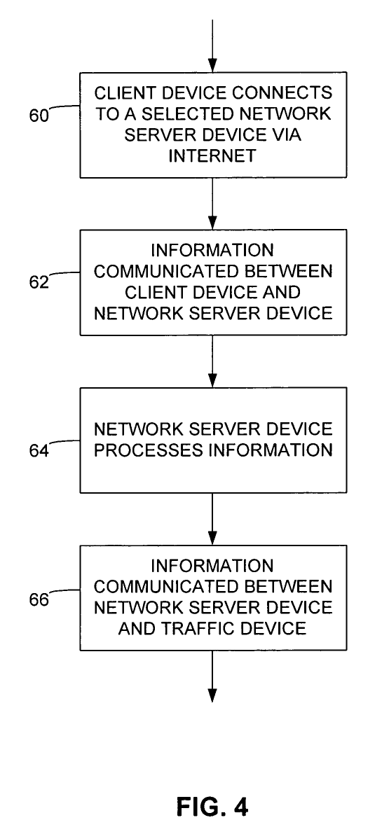

As illustrated in FIG. 4, the method by which the traffic management system operates generally (though not exclusively) begins at a step 60 at which one of client devices 14 makes an initial connection via the Internet 16 (FIGS. 1-2) to one of network server devices 10. Client device 14 does this in the conventional manner in which any computer or wireless mobile device connects to the Internet. For example, a user can open a suitable Web browser (e.g., Microsoft INTERNET EXPLORER®) program and enter a uniform resource locator (URL) that uniquely corresponds to one of network server devices 10. Alternatively, the user can enter a URL of a server that provides a starting or home Web page (not shown) with a list of selectable network server devices 10 or their associated traffic devices from which the user can make a selection. For example, items in the list may indicate traffic devices by their location, e.g., “Fourth & Main Streets.” In any event, as indicated at step 62, the act of entering a URL or otherwise selecting a network server device 10 or associated traffic device causes information to be communicated between the client device 14 and the selected network server device 10 via the Internet 16. Generally, it also causes network server device 10 to serve a Web page (not shown) to the client device 14 that initiated communication. Additional information may be communicated from the client device 14 to the network server device 10 if the Web page is of a type into which a user can enter information and cause it to be transmitted to network server device 10, as described below in further detail.

At a step 64 the network server device 10 in communication with the client device 14 processes information, as described in further detail below with regard to several examples. The processing indicated generally by step 64 can comprise any suitable steps and can relate to processing information received from client device 14 or processing information received from a corresponding traffic device to which network server device 10 is connected. The processing can be extensive or can involve no more than the routing or buffering of data. For example, the processing can include authenticating a user, encoding image information, searching for and retrieving stored information, or analyzing information.

Step 66 indicates the communication of information between the network server device 10 and the traffic device, either from the network server device 10 to the traffic device, from the traffic device to the network server device 10, or both. Steps 60-66 can occur in any suitable order, and the order shown is intended to be merely exemplary. For example, as noted above, the processing that occurs at step 64 can comprise processing of information communicated from the traffic device to the network server device 10 at step 66.

Although in a client-server system such as this, it is generally the client that initiates communication (e.g., at step 60), and the server that responds by providing information (e.g., in the form of a Web page), in some instances the server can initiate communication. Thus, it is contemplated that any one of network server devices 10 can initiate communication with any one of client devices 14.

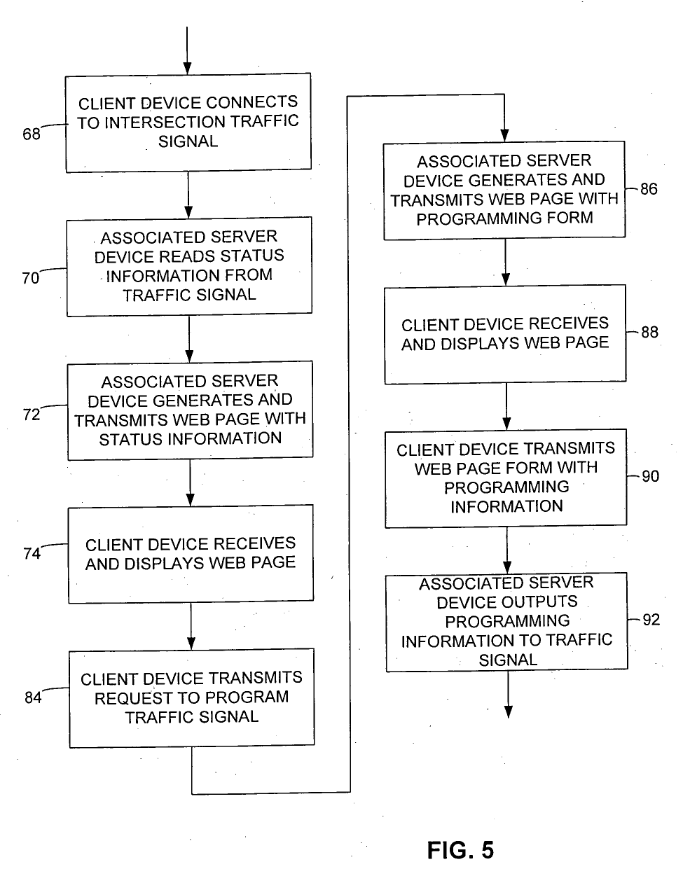

As illustrated in FIG. 5, in one exemplary method of operation of the system, one of client devices 14 is used to interact with an intersection traffic signal 18 (FIG. 2) or similar traffic device. At step 68, client device 14 connects (via the Internet 16) to intersection traffic signal 18. As described above, there is a cabinet near the intersection that contains a network server device 10 that has been programmed and otherwise configured to communicate information to and from intersection traffic signal 18 in the manner described below and as otherwise known in the art. It is that network server device 10 to which client device 14 connects. As illustrated in FIG. 2, that network server device 10 may be connected to other elements associated with that intersection (31), but interaction with those elements is not described in this example for purposes of clarity and illustration. As described above, each traffic device communicates with its own corresponding or associated network server device 10, and each network server device 10 can communicate with any client device 14 without the communications passing through a centralized computer system.

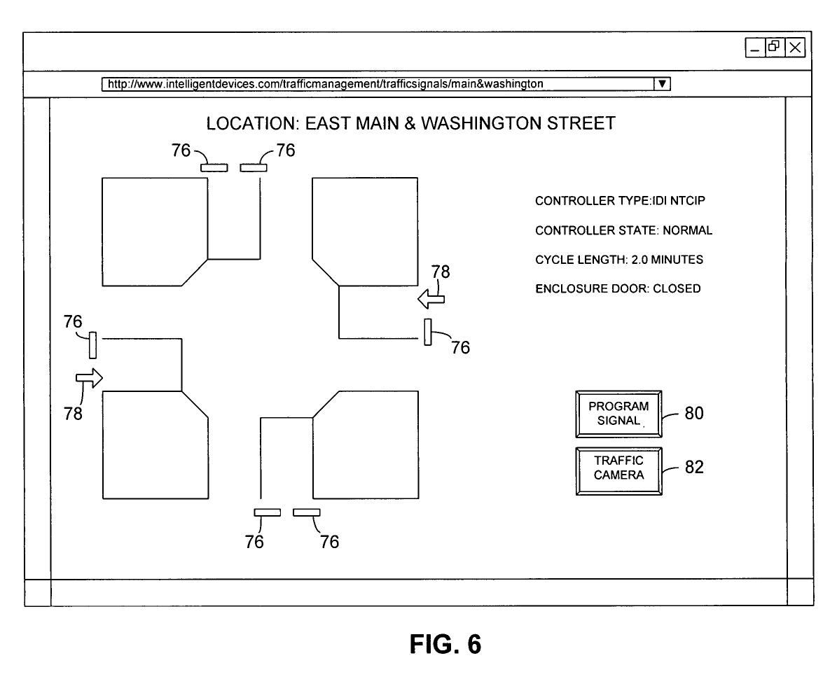

At step 70, the network server device 10 to which the client device 14 connected reads status information from the associated intersection traffic signal 18. Traffic signal status information of the type conventionally readable by a centralized computer system includes intersection status (i.e., red, yellow, or green light), whether the pedestrian “Walk” or “Don't Walk” sign is activated, cycle length of the programmed red-green-yellow cycle, which one of a number of pre-programmed plans may be programmed, whether there is a malfunction such that the signal reverts to a flashing default mode, whether the cabinet door is ajar, and so forth. The network server device 10 puts some or all of this information into the form of a Web page and transmits it to the client device 14, which displays it within a browser window as illustrated in FIG. 6. Web page portions and elements can be pre-stored in memory in network server device 10 along with other data to facilitate generating the completed Web page.

The exemplary Web page illustrated in FIG. 6 includes the location of the intersection (e.g., “East Main & Washington Street”) graphical symbols indicating red lights 76 and green lights 78 for traffic approaching a four-way intersection (e.g., intersection 31 in FIG. 2) from various directions. It also includes some of the above-described status information in textual form, such as the cycle length, whether the door is open or closed, the type of controller (i.e., the native electronics, which are typically contained on a circuit card or board, that directly operate the signal and with which network server device 10 interfaces), the operating state of the controller (e.g., “normal” or “error”), and so forth. Also included in the Web page are several buttons 80 and 82 or similar graphical control and input structures with which a user can interact using a mouse or similar pointing device. In the exemplary Web page, a user can click on button 80 to indicate that the user wishes to program the signal. Similarly, a user can click on button 82 to indicate that the user wishes to view video gathered by a camera device 26 that is part of the same traffic device as intersection traffic signal 18. Other buttons and user interface features can be provided in addition or alternatively to those described above, as the Web page illustrated in FIG. 6 is intended only to be exemplary.

Returning to FIG. 5, a user can select one of these options by, for example, clicking on button 80 at step 84. (Alternatively, the user could click on button 82, as described below.) In response, the client device 14 transmits the information regarding the request to the network server device 10. At step 86, the network server device 10 responds by serving a Web page (not shown) that includes suitable buttons, selection boxes or other graphical control and input structures to receive the user's input describing the cycles and other parameters with which the intersection traffic signal 18 is to be programmed. At step 88, this Web page is displayed in the client device browser window, and the user inputs the information. At step 90, the user clicks on a suitable button (not shown) or otherwise indicates that the user has completed filling in the desired programming information, causing client 14 to transmit the Web page information to the network server device 10. At step 92, the network server device 10 receives the information and outputs the information to the intersection traffic signal 18. Thereafter, the intersection traffic signal 18 operates in accordance with its new programming. The programming of a traffic signal (via its native controller or via a centralized computer system) is well-known in the art and therefore not described in detail herein. Persons skilled in the art will understand that any traffic signal parameter that can be programmed with a conventional centralized computer system can be programmed in the manner described above in accordance with the present invention by providing a suitable Web page form into which the user can enter the information.

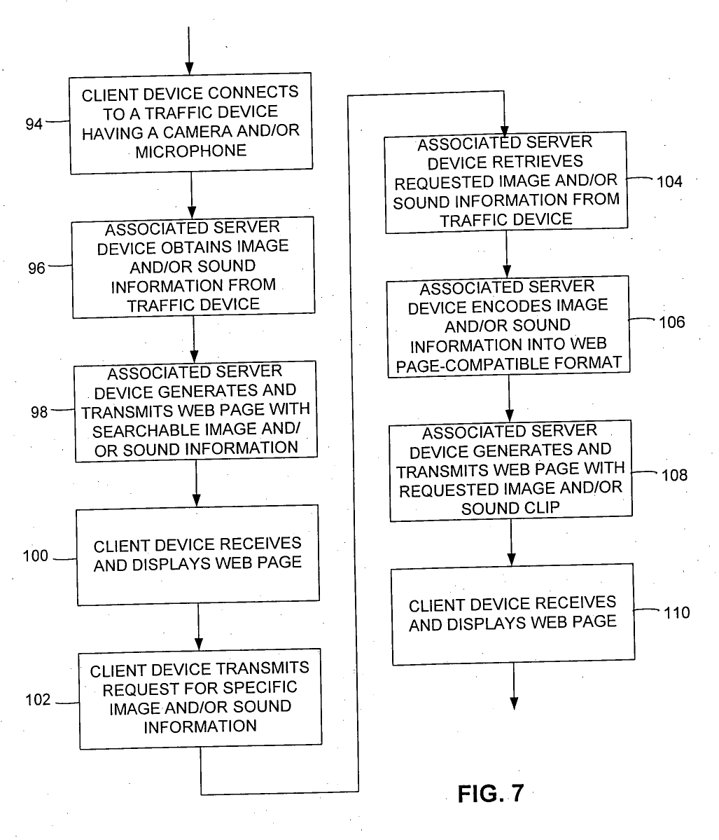

As illustrated in FIG. 7, in another exemplary method of operation of the system, one of client devices 14 is used to interact with a traffic device that includes a camera device 26 (FIG. 2). Camera device 26 can include a microphone. At step 94, client device 14 connects (via the Internet 16) to camera device 26. For example, the user can click on button 82 of the Web page shown in FIG. 6. As described above, there is a cabinet near the intersection that contains a network server device 10 that has been programmed and otherwise configured to communicate information to and from camera device 26 in the manner described below and as otherwise known in the art. This network server device 10 can be the same as that which is associated with other elements located in the intersection 31, such as the intersection traffic signal 18 in the above-described example.

At step 96, the network server device 10 to which the client device 14 connected reads image or sound information gathered in real-time from the associated camera device 26 or, alternatively, from memory in network server device 10 in which earlier-gathered image or sound information has been stored. The image information can be video imagery, individual still frames, a sequence of frames, etc. The network server device 10 can store digitized imagery or sound in a continuous-loop manner or any other suitable manner, including those which are well-known in conventional digital recording devices used for security purposes in buildings and public places. At step 98, the network server device 10 generates and transmits to the client device 14 a Web page (not shown) having graphical control and input features suitable for allowing a user to search from among the pre-stored image information. The Web page may, for example, allow a user to input a date range to request imagery or sound gathered during that time interval. At step 100, the client device 14 receives and displays the Web page. At step 102, the user fills in the Web page with the user's search criteria and clicks a button or otherwise causes the Web page to be transmitted.

At step 104, the network server device 10 uses the received search criteria to retrieve stored image or sound information. Alternatively, the Web page can indicate that the user wishes to view real-time imagery or listen to real-time sound as it is gathered by camera device 26. At step 106, the network server device 10 digitizes and encodes the image or sound information in a Web-compatible format, such as the well-known JPEG or MPEG formats for imagery or WAV format for sound, and at step 108 transmits the encoded image information. At step 110, the client device 14 receives and displays the image or plays the sound. Conventional user interface features can be provided to facilitate viewing images and listening to sound clips. Thus, a user operating the client device can view imagery or sound gathered by a camera device 26 in real-time or view earlier-gathered imagery or sound that has been stored.

Although the imagery and sound-gathering feature described above with regard to FIG. 7 uses Web pages, i.e., the HTTP protocol, in other embodiments of the invention the same or a similar information-gathering feature can use other suitable protocols, such as the Internet file transfer protocol (FTP). Thus, for example, a user can enter an FTP address into a client device 14, to which a network server device 10 responds by uploading stored imagery or sound files to the client device 14.

Motorists can use the above-described feature from their wireless mobile devices to view imagery of current traffic conditions and help them plan alternate routes to minimize delays. A service can be established whereby such persons pay a fee to enable them to access the traffic imagery in the above-described manner. In such an embodiment of the invention, the initial Web page (not shown) can require authentication, such as the user entering an authorized username and password, before network server device 10 will provide the requested imagery. In embodiments of the invention in which authentication is performed, there can be multiple levels of authorization. For example, members of the public who pay to view imagery gathered by camera devices 26 are assigned a low authorization level, which prevents them from affecting the operation of the traffic management system or performing any other function except viewing imagery, while government officials or others who are authorized to affect the operation of the traffic management system are assigned a higher level of authorization, which enables them to program traffic devices and otherwise perform their traffic management job duties.

Authorized government and law enforcement officials can use the above-described imagery and sound-gathering feature to monitor roadways and nearby areas for vehicular and pedestrian traffic relating to prevention and investigation of criminal and terrorist acts. Authorized persons can readily monitor the movement of vehicles and individuals through the traffic management area. Using wireless mobile client devices in the field, such as the laptop computers that are increasingly common in police vehicles, such persons can perform their law enforcement duties more effectively than if they were limited to using a centralized computer system.

The system can also alert officials or others of environmental conditions sensed by traffic devices that include suitable meteorological sensors (e.g., thermometers, anemometers, rain gauges, etc.). As described above, the system shown in FIG. 2 includes an environmental sensor 32. In some embodiments of the invention, environmental sensor 32 can be a meteorological sensor, while in other embodiments it can be a sensor of hazardous gases, radioactive materials, or other materials that, for example, have been released from a vehicle involved in an accident or have been released pursuant to criminal or terrorist acts. Note that essentially the same method described above with regard to FIG. 7 can be performed to provide users with information gathered by environmental sensor 32.

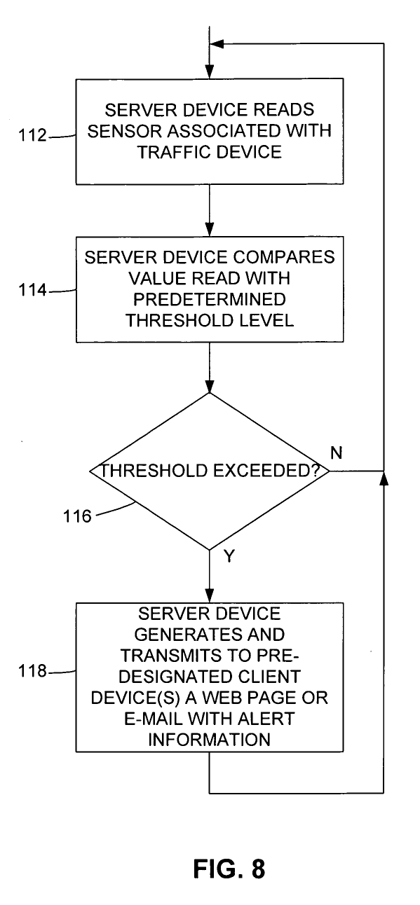

As illustrated in FIG. 8, in some instances network server device 10 can automatically initiate communication with one or more predetermined ones of client devices 14 if a condition occurs to which officials or others are to be alerted. At step 112, a network server device 10 reads a value from the environmental sensor 32 (FIG. 2) to which it is connected. As described above, the value can represent any sensed quantity, such as a temperature, wind speed, rainfall level, or amount of a hazardous material present in a sampled amount of air (e.g., parts-per-million of a contaminant). At step 114, the network server device 10 compares the value read with a predetermined threshold level. If, at step 116, it is determined that the value exceeds the threshold, at step 118 the network server device 10 generates and transmits to one or more client devices 14 a Web page, e-mail message, or other suitable alert, advising the official or other person possessing the client device 14 of the condition. The client devices 14 that are notified can be those in the possession of authorized persons having a need to know of such conditions, such as certain government and law enforcement personnel. Nevertheless, a similar feature, whereby a network server device 10 automatically initiates communication with one or more predetermined client devices 14 if a condition occurs can be used in other embodiments of the invention to advise motorists who subscribe to an alert service of conditions of interest to motorists, such as heavy traffic conditions sensed by roadway sensors.

Although the above-described system of the present invention can entirely supplant a conventional traffic management system of the type in which a central computer directly controls each traffic device through a connection from the central computer to that traffic device, the system of the present invention can alternatively be included in addition to such a conventional traffic management system, i.e., it can operate in parallel with or in conjunction with a conventional traffic management system. For example, each network server device of the present invention or the (conventional) native controller of each traffic device can be connected via a dedicated line or other connection to a central computer system.

It will be apparent to those skilled in the art that various modifications and variations can be made to this invention without departing from the spirit or scope of the invention. For example, although in the exemplary embodiment of the invention the network through which the network server devices communicate with the traffic devices is the Internet, in other embodiments of the invention the network can be any other suitable type of computer network, such as an intranet. Thus, it is intended that the present invention cover the modifications and variations of this invention provided that they come within the scope of any claims and their equivalents. With regard to the claims, no claim is intended to invoke the sixth paragraph of 35 U.S.C. Section 112 unless it includes the term “means for” followed by a participle.

What is claimed is:

1. A system for managing vehicular traffic with a plurality of traffic devices disposed in a corresponding plurality of roadway locations within a localized managed traffic area, comprising:
a plurality of network server devices corresponding in number to the plurality of traffic devices, each network server device having a processor system for controlling network server device operation, a traffic device interface for communicating information with the corresponding one of the traffic devices, and a network interface for communicating the information directly via a computer network with any of a plurality of remotely located client devices operable by users.

2. The system claimed in claim 1, wherein each network server device is disposed in proximity to at least a portion of a corresponding one of the traffic devices at the roadway locations.

3. The system claimed in claim 1, wherein each network server device and at least a portion of one of the traffic devices are housed together in a common structure.

4. The system claimed in claim 1, wherein the traffic device interface communicates information with a traffic device selected from the group consisting of: actuated traffic signal intersection controller; dynamic message sign; environmental sensor system; traffic sensor system; streetlight monitoring and control system; highway advisory radio system; and mass transit system information controller.

5. The system claimed in claim 1, wherein the network interface and the traffic device interface communicate information bidirectionally.

6. The system claimed in claim 1, wherein each network server device further comprises memory for storing a portion of the communicated information.

7. The system claimed in claim 6, wherein at least a portion of the memory is organized as a database for storing a portion of the communicated information.

8. The system claimed in claim 1, wherein the traffic device interface communicates image information with a traffic device having a camera.

9. The system claimed in claim 1, wherein the network interface communicates information via a computer network in a graphical hypertext format, and the network server device serves hypertext pages containing information received from the corresponding one of the traffic devices.

10. The system claimed in claim 9, wherein the network interface communicates information via the World Wide Web.

11. The system claimed in claim 10, wherein:
the traffic device interface receives image information from a traffic device having a camera; and
the network server device encodes the image information in accordance with an image encoding standard format; and
in response to a request received from a client device, the network server device serves a Web page containing, encoded in the image transmission standard format, image information received from the camera.

12. The system claimed in claim 11, wherein:
each network server device further comprises memory for storing the image information; and image information stored in memory is accessible to a client device in response to a request.

13. The system claimed in claim 1, wherein:
the traffic device interface receives environmental information from a traffic device having an environmental sensor;
the network server device detects environmental information relating to a sensed quantity exceeding a predetermined threshold; and
in response to detection of a sensed quantity exceeding a predetermined threshold, the network server device serves an alert to a client device.

14. The system claimed in claim 13, wherein the client device to which an alert is served is a mobile device.

15. A method for managing vehicular traffic with a plurality of traffic devices disposed in a corresponding plurality of roadway locations within a localized managed traffic area, comprising the steps of:
communicating information between a network server device and a remote client device directly via a computer network, the network server device being one of a plurality of network server devices, each corresponding to one of the traffic devices;
the network server device processing the information; and
communicating the information between the network server device and the corresponding one of the traffic devices.

16. The method claimed in claim 15, wherein the step of communicating the information between the network server device and the corresponding one of the traffic devices comprises communicating the information a traffic device selected from the group consisting of: actuated traffic signal intersection controller; dynamic message sign; environmental sensor system; traffic sensor system; streetlight monitoring and control system; highway advisory radio system; and mass transit system information controller.

17. The method claimed in claim 15, wherein the network server communicates information bidirectionally with at least one of the traffic devices.

18. The method claimed in claim 15, wherein the processing step comprises storing a portion of the communicated information.

19. The method claimed in claim 15, wherein the step of communicating the information between the network server device and the corresponding one of the traffic devices comprises communicating the information a traffic device having a camera.

20. The method claimed in claim 15, wherein the step of communicating information between the network server device and a remote client device comprises communicating information in the form of hypertext pages.

21. The method claimed in claim 15, wherein the step of communicating information between the network server device and a remote client device comprises communicating information via the World Wide Web.

22. The method claimed in claim 21, wherein:
the step of communicating the information between the network server device and the corresponding one of the traffic devices comprises the network server device receiving image information from a traffic device having a camera; and
the processing step comprises the network server device encoding the image information in accordance with an image encoding standard format; and
the step of communicating information between the network server device and a remote client device comprises, in response to a request received from a client device, serving a Web page containing, encoded in the image transmission standard format, image information received from the camera.

23. The method claimed in claim 22, wherein the processing step comprises storing the image information in a manner accessible to a client device.

24. The method claimed in claim 15, wherein:
the step of communicating the information between the network server device and the corresponding one of the traffic devices comprises the network server device receiving environmental information from a traffic device having an environmental sensor;
the processing step comprises the network server device detecting whether environmental information relating to a sensed quantity exceeds a predetermined threshold; and
the step of communicating information in a client-server manner between the network server device and a remote client device comprises, in response to detection of a sensed quantity exceeding a predetermined threshold, serving an alert to a client device.

25. The method claimed in claim 24, wherein serving an alert to a client device comprises serving an alert to a mobile client device.

26. The method claimed in claim 15, wherein the processing step comprises:
receiving authentication information from the remote client device identifying a user; and
permitting communication of information between the client device and the corresponding one of the traffic devices in accordance with a permission level associated with an identified user.
